(19) United States
(12) Patent Application Publication
(10) Pub. No.: US 2024/0380571 A1
(43) Pub. Date: Nov. 14, 2024

(54) ENCRYPTION DEVICE, ENCRYPTION METHOD, AND ENCRYPTION PROGRAM

(71) Applicant: KDDI CORPORATION, Tokyo (JP)

(72) Inventors: Yuto NAKANO, Tokyo (JP); Kazuhide FUKUSHIMA, Tokyo (JP)

(73) Assignee: KDDI CORPORATION, Tokyo (JP)

(21) Appl. No.: 18/292,143

(22) PCT Filed: Jul. 26, 2022
(86) PCT No.: PCT/JP2022/028741

§ 371 Date: Jan. 25, 2024

(30) Foreign Application Priority Data
Aug. 3, 2021 (JP) 2021-127442

(51) Int. Cl. H04L 9/06

(52) U.S. Cl. CPC H04L 9/0631; H04L 2209/125

(57) ABSTRACT

An encryption device that implements an encryption scheme in which AES round functions are executed multiple times in order to update each of multiple internal states of a defined bit length, the encryption device being provided with a processing unit that, by calling a single prescribed instruction, collectively processes a group of the round functions that can be executed in parallel, wherein the instruction has an upper limit on a number of bits that can be processed, and the round functions are grouped to minimize a processing load in accordance with a number of times the instruction is called.

### TECHNICAL FIELD

The present invention relates to a high-speed implementation method for an encryption scheme.

The present application claims priority on Japanese Patent Application No. 2021-127442, filed Aug. 3, 2021, the entire disclosure of which is incorporated herein by reference.

### BACKGROUND ART

Conventionally, special instruction sets for executing specific processes at a high speed have sometimes been implemented in processors such as CPUs. For example, an instruction set (AES-NI) for executing AES (Advanced Encryption Standard) processes at a high speed is implemented in Intel (registered trademark) CPUs, etc. By making use of this instruction set, AES round functions can be processed at a high speed. In Non-Patent Document 1, the use of this instruction set to implement high-speed encryption schemes is considered.

### PRIOR ART DOCUMENTS

### Non-Patent Documents

[Non-Patent Document 1] J. Jean and I. Nikolic, “Efficient Design Strategies Based on the AES Round Function”, in Fast Software Encryption, vol. 9783, T. Peyrin, Ed. Berlin, Heidelberg: Springer Berlin Heidelberg, 2016, pp. 334-353.

### SUMMARY OF INVENTION

### Problems to be Solved by the Invention

However, in the above-mentioned conventional instruction set, instructions must be called a number of times equivalent to the number of times that the AES round function is executed, and a sufficiently high speed was not attained.

Therefore, an objective of the present invention is to provide an encryption device, an encryption method, and an encryption program that can execute an encryption scheme using AES round functions at a high speed.

### Means for Solving the Problems

An encryption device according to an embodiment of the present invention implements an encryption scheme in which AES round functions are executed multiple times in order to update each of multiple internal states of a defined bit length, the encryption device including a processing unit that, by calling a single prescribed instruction, collectively processes a group of the round functions that can be executed in parallel, wherein the instruction has an upper limit on a number of bits that can be processed, and the round functions are grouped to minimize a processing load in accordance with a number of times the instruction is called.

In the above-mentioned encryption device, among the multiple round functions, those for which subsequent operations are of the same type may be grouped.

In the above-mentioned encryption device, among the multiple round functions, those for which input values to subsequent operations are at least partially the same may be grouped.

In the above-mentioned encryption device, the round functions may be grouped by multiple instructions having different upper limits on the number of bits that can be processed.

An encryption method according to an embodiment of the present invention is performed when a computer implements an encryption scheme in which AES round functions are executed multiple times in order to update each of multiple internal states of a defined bit length, the encryption method including collectively processing, by calling a single prescribed instruction, a group of the round functions that can be executed in parallel, wherein the instruction has an upper limit on a number of bits that can be processed, and the round functions are grouped to minimize a processing load in accordance with a number of times the instruction is called.

An encryption program according to the present invention makes a computer function as the aforementioned encryption device.

### Advantageous Effects of the Invention

According to the present invention, an encryption scheme using the AES round function can be executed at a high speed.

### BRIEF DESCRIPTION OF DRAWINGS

FIG. 1 is a diagram illustrating an example of a conventional implementation method for an encryption scheme.

FIG. 2 is a block diagram illustrating an encryption device according to an embodiment.

FIG. 3 is a diagram illustrating an example of an implementation method for an encryption scheme according to an embodiment.

### EMBODIMENTS FOR CARRYING OUT THE INVENTION

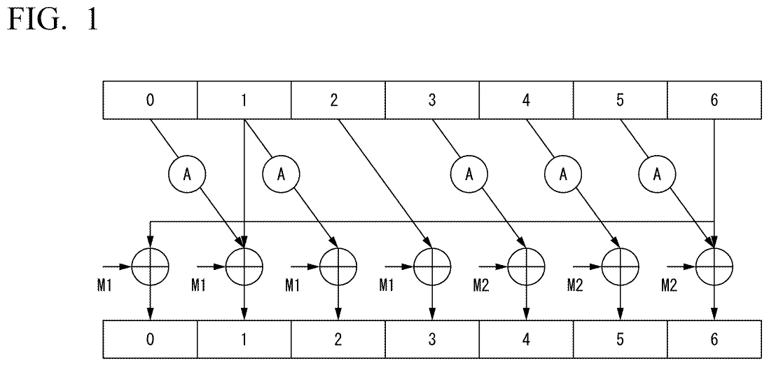

Before explaining embodiments of the present invention, a conventional implementation method for an encryption scheme will be explained with reference to FIG. 1 in order to clarify the differences from the embodiments of the present invention. FIG. 1 is a diagram illustrating an example of a conventional implementation method for an encryption scheme.

This example is one of the configurations proposed in the aforementioned Non-Patent Document 1. In this case, with respect to seven internal states (0 to 6) that are each 128-bit values, the AES round function (A) is executed five times, and XOR operations with messages (M1 or M2) are executed seven times to convert them to new internal states.

In this case, the processing speed of the encryption scheme overall is increased by implementing an instruction set that executes round functions at a high speed.

In this implementation method, as illustrated in FIG. 1, an encryption device that implements an encryption scheme in which AES round functions are executed multiple times in order to update each of multiple internal states of a defined bit length (for example, 128 bits) is provided.

Hereinafter, an example of an embodiment of the present invention will be explained.

In the present embodiment, the conventional implementation method for an encryption scheme is improved by using an instruction set prepared for a specific CPU, thereby reducing the number of processing cycles necessary for executing the AES round functions, thus realizing a higher speed.

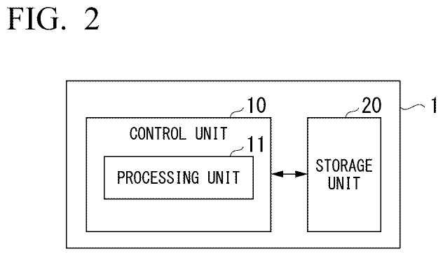

FIG. 2 is a block diagram illustrating the functional configuration of an encryption device 1 according to the present embodiment.

The encryption device 1 is an information processing device (computer) provided with a control unit 10 and a storage unit 20, as well as various input/output interfaces, etc.

The control unit 10 is a portion that controls the encryption device 1 overall, and that realizes the respective functions of the present embodiment by appropriately reading out and executing various programs stored in the storage unit 20. The control unit 10 may be a CPU.

The storage unit 20 is a storage area for various programs, various data, etc., for making a hardware group function as the encryption device 1, and may be a ROM, a RAM, a flash memory, a hard-disk drive (HDD), etc.

Specifically, the storage unit 20 stores a program (encryption program), etc. for making the control unit 10 execute the respective functions of the present embodiment.

The control unit 10 functions as a processing unit 11 by executing an encryption program. The processing unit 11, by calling a single prescribed instruction, collectively processes a group of round functions that can be executed in parallel.

In this case, the prescribed instruction that is implemented in the control unit 10 (processor) and that is called by the processing unit 11 has an upper limit on the number of bits that can be processed, and the round functions are grouped to minimize the processing load in accordance with the number of times the instruction is called.

For example, Intel CPUs of the Ice Lake generation implement the following two instructions that can process 256 bits and 512 bits at once:
m256i_mm256_aesenc_epi128 (_m256i a, _m256i RoundKey)
m512i_mm512_aesenc_epi128 (_m512i a, _m512i RoundKey)

By calling these instructions a single time, round function processes can be executed at the same time on inputs (multiple internal states) that are up to 256 bits (equivalent to two round functions) or 512 bits (equivalent to four round functions) long.

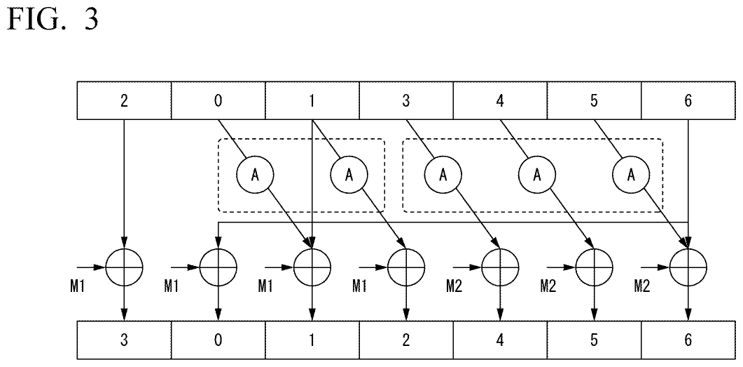

FIG. 3 is a diagram illustrating an example of the implementation method for an encryption scheme according to the present embodiment.

In the implementation method illustrated for the conventional example (FIG. 1), the processes for executing the AES round functions needed to be called a total of five times.

In contrast therewith, in the implementation method according to the present embodiment, the round functions (with 128-bit inputs) that are executed a total of five times are grouped so as to be executed, for example, two times and three times. Thus, the processing unit 11 processes two round functions by an instruction with a 256-bit input and processes three round functions by an instruction with a 512-bit input, so that the round functions are collectively processed a single time.

As a result thereof, processes conventionally requiring (the number of cycles in each round ×5) cycles can be executed by reducing the number of cycles to (the number of cycles in each round ×2).

In the example in FIG. 3, the five round functions are independent of each other and have no constraints in terms of the order of execution, and therefore can be executed algorithmically in parallel. Thus, they may be grouped in any combination. However, the combination should preferably be determined as indicated below in order to better improve the processing efficiency.

In various encryption schemes, the results of operations by round functions are often further converted by subsequent operations.

At this time, the processing can be made more efficient by grouping together the round functions, among multiple round functions, for which subsequent operations are of the same type (for example, XOR, AND, etc.), and by further grouping together the round functions, among multiple round functions, for which input values (messages) to subsequent operations are at least partially the same.

For example, in the example in FIG. 3, two round functions for the internal states 0 and 1 are grouped because the same message M1 is input to the subsequent XOR operations, and they are executed at the same time by an instruction for processing 256 bits or an instruction for processing 512 bits.

Additionally, the three round functions for the internal states 3 to 5 are collected as a group to which the same message M2 is input to the subsequent XOR operations, and they are executed at the same time by an instruction for processing 512 bits.

When multiple instructions can be used, such as those for 256 bits and for 512 bits mentioned above, if the processing loads are different from each other in accordance with the number of times the instructions are called, the overall processing loads can be compared for combinations of instructions and groups of round functions, and the groups and commands minimizing the processing load may be chosen.

According to the present embodiment, prescribed instruction sets implemented in a processor are used in an encryption scheme having AES round functions as constituent elements. Thus, the encryption device 1 can collectively execute multiple round functions and can reduce the overall number of processing cycles, i.e., the processing time, required for encryption and decryption. As a result thereof, the encryption processing speed can be increased, and furthermore, higher-speed encrypted communication, etc. can be realized.

The encryption device 1 can make the overall processing even more efficient by processing the round functions by grouping together those, among the multiple round functions, in which subsequent operations are of the same type, and furthermore, those in which input values to subsequent operations are at least partially the same.

Additionally, the encryption device 1 can appropriately group the round functions and make the processing more efficient by appropriately selecting multiple instructions having different upper limits on the number of bits that can be processed.

The aforementioned embodiment can, for example, realize high-speed encryption processes, and thus can contribute to Goal 9, “Build resilient infrastructure, promote inclusive and sustainable industrialization and foster innovation”, of the sustainable development goals (SDGs) set forth by the United Nations.

While an embodiment of the present invention has been explained above, the present invention is not limited to the embodiment above. Additionally, the effects described for the embodiment above are merely an accounting of the most favorable effects obtained by the present invention, and the effects of the present invention are not limited to those described for the embodiment.

The encryption method according to the encryption device 1 can be realized by software. When realized by software, programs constituting this software are installed in an information processing device (computer). Additionally, these programs may be recorded on removable media such as CD-ROMs and distributed to users, or they may be distributed by being downloaded to users' computers via a network. Furthermore, these programs may be provided to users' computers as web services via a network without being downloaded.

### REFERENCE SIGNS LIST

1 Encryption device
10 Control unit
11 Processing unit
20 Storage unit

1. An encryption device that implements an encryption scheme in which Advanced Encryption Standard (AES) round functions are executed multiple times in order to update each of multiple internal states of a defined bit length, the encryption device comprising:
a processor that, by calling a single prescribed instruction, collectively processes a group of the round functions that can be executed in parallel,
wherein the instruction has an upper limit on a number of bits that can be processed, and the round functions are grouped to minimize a processing load in accordance with a number of times the instruction is called.

2. The encryption device according to claim 1, wherein, among the multiple round functions, those for which subsequent operations are of the same type are grouped.

3. The encryption device according to claim 2, wherein, among the multiple round functions, those for which input values to subsequent operations are at least partially the same are grouped.

4. The encryption device according to claim 1, wherein the round functions are grouped by multiple instructions having different upper limits on the number of bits that can be processed.

5. An encryption method performed when a computer implements an encryption scheme in which AES round functions are executed multiple times in order to update each of multiple internal states of a defined bit length, the encryption method comprising:
collectively processing, by calling a single prescribed instruction, a group of the round functions that can be executed in parallel,
wherein the instruction has an upper limit on a number of bits that can be processed, and the round functions are grouped to minimize a processing load in accordance with a number of times the instruction is called.

6. A non-transitory computer recording medium storing an encryption program for making a computer function as an encryption device that implements an encryption scheme in which Advanced Encryption Standard (AES) round functions are executed multiple times in order to update each of multiple internal states of a defined bit length to perform:
collectively processing, by calling a single prescribed instruction, a group of the round functions that can be executed in parallel,
wherein the instruction has an upper limit on a number of bits that can be processed, and the round functions are grouped to minimize a processing load in accordance with a number of times the instruction is called.
